(19) United States
(12) Patent Application Publication
(10) Pub. No.: US 2005/0202253 A1
(43) Pub. Date: Sep. 15, 2005

(54) Wooden board and a method for producing a wooden board

(76) Inventor: Thomas Grafenauer, Onzour sur Loire (FR)

Correspondence Address: WHITHAM, CURTIS & CHRISTOFFERSON, P.C., 11491 SUNSET HILLS ROAD, SUITE 340, RESTON, VA, 20190, US

(21) Appl. No.: 11/052,468

(22) Filed: Feb. 8, 2005

(30) Foreign Application Priority Data
Feb. 9, 2004 (DE) 10 2004 006 385.0

(51) Int. Cl. B32B 27/40

(52) U.S. Cl. 428/423.1

(57) ABSTRACT

The invention relates to a wooden board and a method for producing a material board, in which a layer 3 of a foamed plastic is introduced between two layers of wooden material 2, 4.

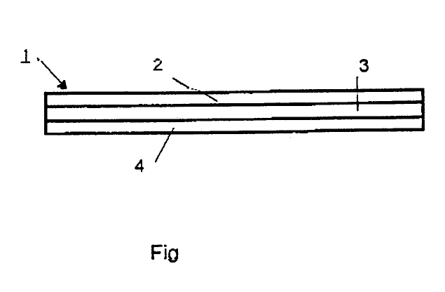

The invention relates to a wooden board and a method for producing a wooden board.

Wooden boards is understood to mean board-like plywood, chipboards, such as flat pressed boards, extruded boards, OSB boards, cabinet making boards, wooden fiber boards, such as MDF or HDF fibers, and other wooden boards such as laminated wooden boards, laminated wooden moldings or else pressed laminated wood. In particular in the case of wooden boards in the furniture industry, the problem arises that stable boards are relatively heavy because of their thickness, which can lead to transport problems, in particular for self-builders.

It is an object of the present invention to provide a lightweight and stable wooden board having a hard surface and also a method for its production.

According to the invention, this object is achieved by a wooden board having the features of claim 1 and a method having the features of claim 11. Advantageous refinements and developments of the invention are listed in the subclaims.

According to the invention, a layer of foamed, preferably cured plastic, is arranged between two layers of wooden material, in order to reduce the density at the center of the wooden board. This means that the wooden board according to the invention is of lightweight design as compared with conventional wooden boards. Nevertheless, the outer sides have the wooden structure, so that when oriented chips are used, for example, an OSB surface is produced.

In order to achieve high rigidity, provision is made for the plastic to be designed to have closed pores in the foamed state, curing taking place after foaming in order to achieve maximum stability. The foamed and cured plastic then forms a layer of lower density in relation to the layers of wooden material enclosing it and, at the same time, provides high strength.

The plastics can consist of polyethylene or polyurethane and preferably contain flameproofing agents, such as melamine resin, aluminum hydroxide or ammonium polyphosphate. Other additives or flameproofing agents can be added to the plastic to be foamed in order to match the properties of the wooden board to the respective requirements.

Since wooden boards are generally produced under pressure and with a supply of thermal energy, provision is made for the plastic to be capable of thermal activation, that is to say the foaming agent present within the plastic begins to react. The foaming reaction can be controlled via the supply of energy or via cooling of the wooden board and therefore also of the plastics, so that the level of foaming can be adjusted by the duration of the action of temperature. The foaming agent reacts under the supply of thermal energy and foams the plastic.

The foamed plastic layer can be formed as a core which is surrounded by the wooden material; alternatively, only the upper and lower side of the plastic layer can be covered by the layers of wooden material. The wooden materials used can be plywood, chipboards, wood fibers or laminated wood, use preferably being made of chips or wood fibers, in order to achieve optimum crosslinking between the wooden materials and the foamed plastic. For reasons of symmetry, the plastic layer is arranged centrally within the wooden board; should different arrangements or spreading thicknesses be necessary on the basis of strength considerations, this can of course also be implemented.

One development of the invention provides for locking devices to be arranged or formed on the side edges on a wooden board, so that a plurality of such wooden boards can be joined to one another by locking devices. In addition to the usual tongue and groove connections, form-fitting locking means can be provided which act in the vertical and horizontal direction, that is to say in the plane of the board or perpendicular to the plane of the board.

The method according to the invention for producing a wooden board provides for a layer of a foaming, curing plastic to be introduced between two layers of a wooden material and for the plastic to be foamed. In this case, the layers of wooden material can have different materials, for example that on the upper side oriented chips are applied for an OSB appearance and on the underside wood fibers for an MDF or HDF board.

One possible way of introducing the plastic or the plastic granules into the interior of a wooden board provides for a first layer of a wooden material to be applied initially and for a layer of plastic or plastic granules to be spread out on this. The two layers are then covered by a second layer of wooden material, before the plastic is foamed by means of the supply of thermal energy. The layer of wooden material is in this case either placed on or, in the case of chips or fibers, spread out or poured on.

As an alternative to this, in the case of chip or fiber materials, provision is made for these to be spread out as a chip or fiber cake. This chip or fiber cake is divided, for example by a steamer blade, and the plastic or the plastic granules are then introduced into the divided joint between the upper and lower layer.

The raw materials for the wooden board to be fabricated are put into a press, following the appropriate layering, and are pressed together. The thickness of the wooden board is in this case set by the press, the density of the wooden board by the quantity of wooden materials and the quantity of plastic to be foamed. The press is preferably heated, so that the thermally activated plastic foams up and expands. The wooden material located on the upper side and the underside is thereby pressed against the press, which means that a very high density and, accordingly, a very high strength of the wooden materials is implemented on the upper side and on the underside. The plastic foams up in the center between the layers of wooden material and increases the volume. In order that the wooden board to be produced is given the desired thickness, the latter is set by the press in that the press is locked during the foaming process, that is to say the board thickness remains substantially constant. As an alternative to this, it is possible for the press to move apart slightly until the desired intended dimension is reached.

After the intended dimension has been reached or following the setting of the intended dimension, after the thermal energy has been supplied the press is held at this intended dimension until the foamed plastic is no longer active and has preferably cured. The board thickness can be set exactly as a result of holding to the intended dimension in the press.

The plastic is spread out as granules between the layers of material, in particular fibers or chips, uniform spreading out over the entire width and length of the board preferably being carried out, which is possible in the course of continuous board fabrication by means of successively spreading out the appropriate materials.

In order to achieve improved attachment of the foamed plastic to the wooden materials, in particular in the case of fibers or chips, provision is made for a mixture of wooden materials and plastic granules to be spread out between the two outer layers of wooden material, which ensures improved crosslinking.

The single FIGURE shows a wooden board 1, on whose upper side a first layer of wooden material 2 is arranged. On the underside there is a second layer of wooden material 4; a layer 3 of a foamed, cured plastic is arranged between the two layers of wooden material 2, 4. There can be locking elements on the side edges of the wooden materials 1. The layers of wooden material 2, 4 can be formed as chips or wood fibers, similar to the production of a chipboard, an MDF board or an OSB board. Production is carried out in that the second layer of wooden material 4 is initially spread out, then a layer 3 of plastic granules which can be foamed by supplying thermal energy is spread out. The second layer of wooden material 2 is spread out as a top layer and moved into a continuous hot press. There, the layers are compacted to the intended dimension and the plastic is foamed by the thermal energy supplied. As a result, the density is reduced in the center of the wooden board 1 and pressure is applied to the outer sides of the wooden board 1, so that the layers 2, 4 are highly compacted.

In the cured state, the plastic layer 3 is rigid and, because of the lower specific weight, permits the construction of a lightweight and rigid wooden board 1.

The visible surfaces of the layers of wooden material 2, 4 can be coated, printed or varnished in accordance with the desire for decoration or in accordance with the envisaged intended use. Likewise, a layer of veneer can be applied, so that the wooden board is suitable as a furniture material.

1. Wooden board having a layer of foamed plastic (3), which is arranged between two layers of wooden material (2, 4).

2. Wooden board according to claim 1, characterized in that the plastic is designed to have closed pores in the foamed state.

3. Wooden board according to claim 1, characterized in that the plastic is bonded to the layers of wooden material and cured.

4. Wooden board according to claim 1, characterized in that the plastic has at least proportions of polyethylene or polyurethane.

5. Wooden board according to claim 1, characterized in that the plastic contains flameproofing agents, in particular melamine resin, aluminum hydroxide or ammonium polyphosphate.

6. Wooden board according to claim 1, characterized in that the plastic can be activated thermally.

7. Wooden board according to claim 1, characterized in that the plastic layer (2) is formed as a core which is surrounded by wooden material.

8. Wooden board according to claim 1, characterized in that the wooden material is formed of plywood, chips, wood fibers or laminated wood.

9. Wooden board according to claim 1, characterized in that the plastic layer (3) is arranged centrally in the board (1).

10. Wooden board according to claim 1, characterized in that locking devices for joining a plurality of wooden boards (1) are formed on the side edges.

11. Method for producing a wooden board, characterized in that a layer of a foaming, curing plastic is introduced between two layers of a wooden material and the plastic is foamed.

12. Method according to claim 11, characterized in that the plastic is applied to a first layer of wooden material (4) and covered by a second layer of wooden material (2) before the plastic is foamed.

13. Method according to claim 11, characterized in that a chip of fiber cake is spread out, this is then divided, in particular by a steamer blade, and the plastic is introduced into the divided joint before the plastic is foamed.

14. Method according to claim 11, characterized in that heat is supplied to the layers of wooden material (2, 4) and the plastic layer (3) via press platens.

15. Method according to claim 11, characterized in that the thickness of the wooden board (1) is set by a press.

16. Method according to claim 15, characterized in that, during the foaming process, the press maintains the plate thickness substantially constant or moves apart to the intended dimension.

17. Method according to claim 15, characterized in that, after reaching the intended dimension of the wood board (1), the press is held until the foamed plastic has cured.

18. Method according to claim 11, characterized in that the plastic is spread out as granules between the layers of wooden material.

19. Method according to claim 18, characterized in that the plastic granules are spread out uniformly over the entire width and length of the wooden board (1).

20. Method according to claim 11, characterized in that a mixture of wooden material and plastic granules is introduced between two layers of wooden material.
